(19) United States
(12) Patent Application Publication
(10) Pub. No.: US 2012/0129004 A1
(43) Pub. Date: May 24, 2012

(54) HOUSING AND METHOD FOR MANUFACTURING HOUSING

(75) Inventors: HSIN-PEI CHANG, Tu-Cheng (TW); WEN-RONG CHEN, Tu-Cheng (TW); HUANN-WU CHIANG, Tu-Cheng (TW); CHENG-SHI CHEN, Tu-Cheng (TW); MAN-XI ZHANG, Shenzhen (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/091,285

(22) Filed: Apr. 21, 2011

(30) Foreign Application Priority Data
Nov. 22, 2010 (CN) 201010553783.8

(51) Int. Cl. C23C 28/02; B32B 15/01

(52) U.S. Cl. 428/658; 205/186; 428/674; 428/680; 428/681

(57) ABSTRACT

A housing includes a magnesium or magnesium alloy substrate, a first metal layer formed on the substrate by physical vapor deposition, and a second metal layer formed on the first metal layer by electroplating. The first metal layer is comprised of one or more metals selected from the group consisting of zinc, iron, copper, and nickel.

### BACKGROUND

1. Technical Field

The exemplary disclosure generally relates to housings and a method for manufacturing the housings.

2. Description of Related Art

Due to having many good properties such as light weight and quick heat dissipation, magnesium and magnesium alloy are widely used in making components (such as housings) of electronic devices. However, magnesium and magnesium alloy have a lower erosion resistance.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the exemplary housing and method for manufacturing the housing. Moreover, in the drawings like reference numerals designate corresponding parts throughout the several views. Wherever possible, the same reference numbers are used throughout the drawings to refer to the same or like elements of an embodiment.

FIG. 1 is a cross-sectional view of an exemplary embodiment of a housing.

FIG. 2 is a schematic view of a magnetron sputtering machine for manufacturing the housing in FIG. 1.

### DETAILED DESCRIPTION

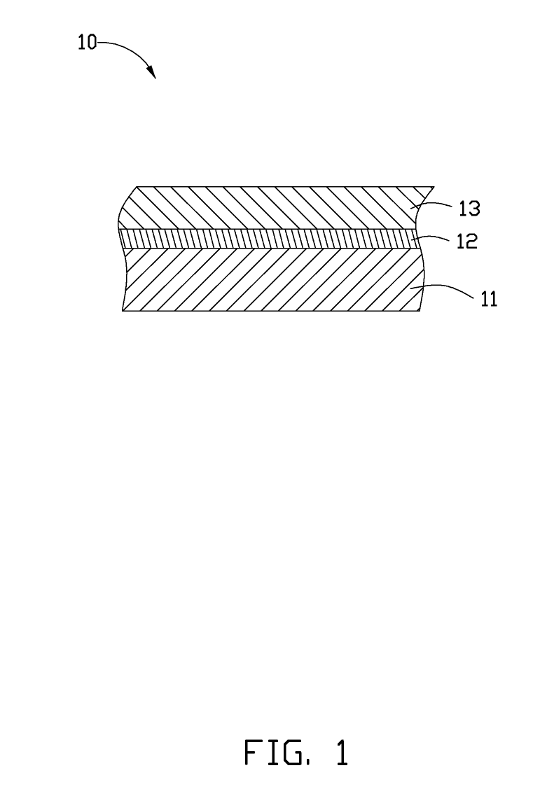

Referring to FIG. 1, an exemplary housing 10 includes a substrate 11 made of magnesium or magnesium alloy. A first metal layer 12 is directly deposited on the substrate 11, and a second metal layer 13 is directly deposited on the first layer 12.

The first metal layer 12 may be comprised of one or more materials selected from the group consisting of zinc, iron, copper, and nickel. The first metal layer 12 is deposited by a physical vapor deposition (PVD) method, such as magnetron sputtering, vacuum evaporation, or arc ion plating. In this exemplary embodiment, the first metal layer 12 is formed by magnetron sputtering. The first metal layer 12 may have a thickness of about 2.0 μm˜3.0 μm.

The second metal layer 13 is an electroplated layer. The second metal layer 13 may be comprised of chromium. The thickness of the second metal layer 13 may be about 5.0 μm˜10 μm.

An exemplary method for manufacturing the housing 10 includes the following steps.

A substrate 11 is provided. The substrate 11 may be made of magnesium or magnesium alloy and may be formed by punching.

The substrate 11 is pretreated. The substrate 11 is ultrasonically cleaned with a solution (e.g., alcohol or Acetone) in an ultrasonic cleaner, to remove impurities such as grease or dirt from the substrate 11. Then, the substrate is dried.

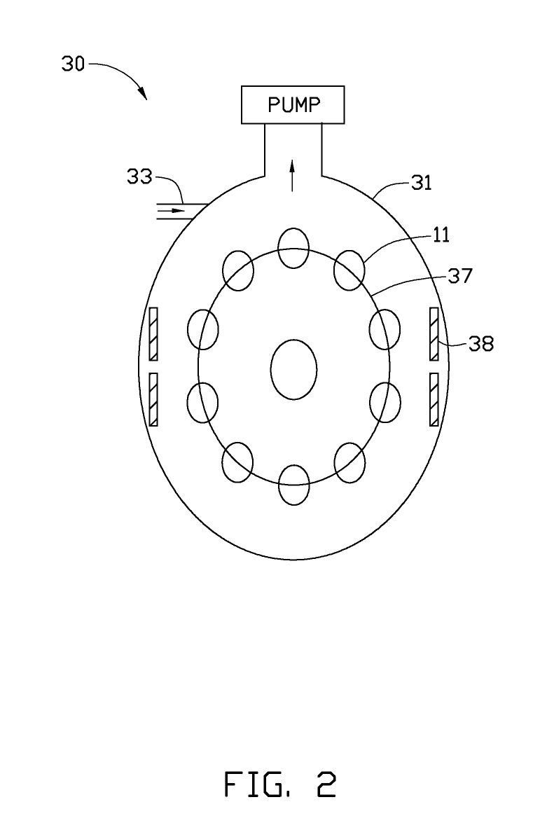

The first metal layer 12 is formed on the substrate 11 by a PVD method, such as magnetron sputtering, vacuum evaporation, and arc ion plating. In this exemplary embodiment, the first metal layer 12 is formed by magnetron sputtering. Before depositing the first metal layer 12, the substrate 11 is cleaned by argon plasma cleaning. The substrate 11 is retained on a rotating bracket 37 in a vacuum chamber 31 of a magnetron sputtering machine 30 as shown in FIG. 2. The vacuum chamber 31 is evacuated to maintain a vacuum level of about 8.0×10⁻³ Pa. Pure argon is supplied into the vacuum chamber 31 at a flux of about 300 Standard Cubic Centimeters per Minute (sccm) to about 600 sccm from a gas inlet 33, to generate plasma. A bias voltage is applied to the substrate 11 in a range from about −300 volts to about −800 volts for about 3 min to about 10 min. The substrate 11 is washed by argon plasma to further remove any grease or dirt. Thus, the binding force between the substrate 11 and the first metal layer 12 is enhanced.

Once the argon plasma cleaning is finished, the flux of the argon supplied into the vacuum chamber 31 is adjusted to be in a range from about 150 sccm to about 300 sccm. The temperature in the vacuum chamber 31 is maintained at 50° C.˜150° C. The speed of the rotating bracket 37 is from about 0.5 revolutions per minute (rpm) to about 3 rpm. The targets 38 are made of one or more metals selected from the group consisting of zinc, iron, copper. Power of the electric field applied to at least one target 38 is about 5 kw to about 10 kw. A bias voltage is applied to the substrate 11 in a range from −50 to −300 volts for about 20 minutes to about 60 minutes, depositing the first metal layer 12 on the substrate 11.

The second metal layer 13 is formed on the second metal layer 12 by electroplating. In this exemplary embodiment, the second metal layer 13 is comprised of chromium. The electroplating process is carried out in an electrolyte containing 100˜200 g/L chromic anhydride, 1˜2 g/L sulphuric acid, and 1.5˜2.5 g/L glycine, using the substrate 11 with the first metal layer 12 as a cathode. An electrical current with a density of about 2.0˜8.0 A/dm² is applied between the electrolyte and the substrate 11 for about 10˜60 minutes, to plate the second metal layer 12. The electrolyte is maintained at a temperature of about 40˜60° C.

The first metal layer 12 comprised of metal as described above has an electrode potential closely matching the electrode potential of the substrate 11, therefore, galvanic corrosion between the substrate 11 and the first metal layer 12 can be avoided in the electroplating process. Furthermore, the second metal layer 13 formed by electroplating can improve the density of the entire coating of the housing 10 to improve the erosion resistance of the housing 10.

It is to be understood, however, that even through numerous characteristics and advantages of the exemplary disclosure have been set forth in the foregoing description, together with details of the system and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A housing, comprising:
a magnesium or magnesium alloy substrate;
a first metal layer formed on the substrate by physical vapor deposition, the first metal layer being comprised of one or more metals selected from the group consisting of zinc, iron, copper, and nickel;
a second metal layer formed on the first metal layer by electroplating.

2. The housing as claimed in claim 1, wherein the first metal layer is formed by magnetron sputtering.

3. The housing as claimed in claim 1, wherein the first metal has thickness of about 2.0 μm˜3.0 μm.

4. The housing as claimed in claim 1, wherein the second metal layer is comprised of chromium.

5. The housing as claimed in claim 1, wherein the second metal layer has a thickness of about 5.0 μm˜10 μm.

6. A method for manufacturing a housing comprising steps of:
providing a substrate made of magnesium or magnesium alloy;
forming a first metal layer on the substrate by physical vapor deposition, the first metal layer being comprised of one or more metals selected from the group consisting of zinc, iron, copper, and nickel;
electroplating a second metal layer on the first metal layer.

7. The method of claim 6, wherein the first metal layer is formed by magnetron sputtering.

8. The method of claim 7, wherein during magnetron sputtering the first metal layer, the temperature for magnetron sputtering is 50° C.˜150° C.; argon is supplied with a flux of about 100 sccm to about 300 sccm; a bias voltage applied to the substrate is in a range from −50 volts to −300 volts, and a target made of one or more metals selected from the group consisting of zinc, iron, copper, and nickel is evaporated by applying a power from about 5 kw to about 10 kw for about 20 minutes to 60 minutes.

9. The method of claim 6, wherein the second metal layer is comprised of chromium.

10. The method of claim 9, wherein the electroplating process is carried out in an electrolyte containing 100˜200 g/L chromic anhydride, 1˜2 g/L sulphuric acid, and 1.5˜2.5 g/L glycine, using the substrate with the first metal layer as a cathode, applying a electrical current with a density of about 2.0˜8.0 A/dm² between the electrolyte and the substrate for about 10˜60 minutes.

11. The method of claim 10, wherein the electrolyte is maintained at a temperature of about 40˜60° C. during the electroplating process.

12. The method of claim 6, further including a step of ultrasonic cleaning the substrate before forming the first metal layer.

13. The method of claim 12, further including a step of argon plasma cleaning the substrate between the steps of ultrasonic cleaning and forming the first metal layer.
